(19) United States
(12) Patent Application Publication
(10) Pub. No.: US 2006/0253567 A1
(43) Pub. Date: Nov. 9, 2006

(54) System and method for utilizing a sip events framework to deliver syndication feeds

(75) Inventors: Jari Selin, Espoo (FI); Mikko Lonnfors, Helsinki (FI); Aki Niemi, Helsinki (FI)

Correspondence Address: FOLEY & LARDNER LLP, 321 NORTH CLARK STREET, SUITE 2800, CHICAGO, IL, 60610-4764, US

(73) Assignee: Nokia Corporation

(21) Appl. No.: 11/121,539

(22) Filed: May 4, 2005

(51) Int. Cl. G06F 15/173

(52) U.S. Cl. 709/224

(57) ABSTRACT

A system and method for applying a SIP events framework in order to deliver syndication feeds. The invention includes a feed delivery server and a feed consumption client. The feed consumption client uses a SIP SUBSCRIBE method to subscribe to the feed. Once the feed consumption client has subscribed to the feed, the feed delivery server starts delivering new feed items using a SIP NOTIFY method whenever new information becomes available, providing a PUSH mechanism where new material is provided to the client when available.

### FIELD OF THE INVENTION

The present invention relates generally to the provision of feeds using Session Initiation Protocol (SIP) events. More particularly, the present invention relates to the delivery of rich site summary (RSS) feeds and Atom feeds using a SIP events framework.

### BACKGROUND OF THE INVENTION

RSS is a format used for syndicating news and the content of news-like web sites. RSS is an umbrella term for a format that spans several versions and at least two parallel formats. There are currently about ten different versions of RSS. Most news sites provide RSS feeds, and RSS is also used to distribute wiki and blog changes.

There is currently a desire to define a single standard protocol to phase out different version of RSS. Atompub is a working group in the Internet Engineering Task Force (IETF) that is standardizing Atom format and protocols. Atom is a simple method for reading and writing information on the web, allowing a user to easily keep track of more sites in less time, and to seamlessly share the user's words and ideas by publishing the ideas to the web. Atom defines a feed format for representing feeds and a protocol for editing Web resources. Currently, neither RSS nor Atom specifies a transport protocol for feeds, although hypertext transfer protocol (HTTP) is regularly used.

Session Initiation Protocol (SIP) is a widely used protocol that is used to set up calls and implement presence and messaging services. IP Multimedia Subsystem (IMS) capable mobile devices and networks are developing SIP infrastructure, and SIP services are also offered in the Internet. The SIP events framework defines SIP SUBSCRIBE and NOTIFY methods.

Atom feeds are delivered to clients using HTTP. The client polls a given feed's Uniform Resource Locator (URL) at predetermined intervals to determine if there has been a change to the feed. The feed itself is a structured text document represented in eXtended Markup Language (XML).

For a client terminal to obtain the feed items as quickly as possible, it has to poll the URL in short enough intervals. For example, if a client wants to have the newly-arrived item available within ten minutes of its appearance, it must poll the source in an interval of less than ten minutes. This is referred to as a POLL method.

For a personal computer client having access to a rapid, flat rate Internet connection, this POLL method is usually not a significant issue. For a mobile device that has limited bandwidth and battery capacity, however, frequent polling is suboptimal. Additionally, frequent polling causes additional loads to a server that is providing the feeds. If the feed item needs to be delivered instantly, the HTTP polling method is not suitable at all.

### SUMMARY OF THE INVENTION

This present invention provides a system and method for applying the SIP events framework in order to deliver RSS/Atom syndication feeds. The invention includes a feed delivery server and a feed consumption client. The feed delivery server is a SIP event server. Clients use the SIP SUBSCRIBE method to subscribe to the feed. Once the client has subscribed to the feed, the server starts delivering new feed items using the SIP NOTIFY method whenever new information becomes available, essentially providing a PUSH mechanism where new materials is provided to the client whenever it becomes available to the server. Alternatively, the feed delivery server can simply notify the client of changes in the feed. The SIP server may generate the feed itself, or it may use any feed that is available on the network. If an existing feed is used, the server polls the feed source, checks for new items and then generates the SIP NOTIFY for each subscribed client. The client may reside on a personal computer, a mobile device or in any other device that supports SIP.

In one embodiment of the invention, the SIP PUBLISH method can be used by external feed sources to publish the feed. With this particular embodiment, the system of the present invention becomes more intelligent, and the feed delivery server does not have to poll the feed source on a continuous basis.

With the present invention, the benefit of a PUSH mechanism can be achieved over the current POLL mechanism used in conventional feeds. Adding the SIP SUBSCRIBE/NOTIFY method also allows for new use cases for the feeds. The present invention can also minimize network traffic and battery consumption on mobile devices, while providing better service to end users. A system operating according to the present invention can utilize existing SIP infrastructure, and may lower the processing requirements on the server side of the system. The present invention functions effectively with already existing SIP-based services, and already-implemented functions for SIP can be utilized with the present invention. The present invention is also easy to integrate to an IMS or other SIP-based system architecture.

These and other objects, advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is an overview diagram of a system within which the present invention may be implemented;

FIG. 2 is a perspective view of a mobile telephone that can be used in the implementation of the present invention;

FIG. 3 is a schematic representation of the telephone circuitry of the mobile telephone of FIG. 2; and

FIG. 4 is a representation of the exchange of information between a feed consumption client and a feed consumption server according to one embodiment of the present invention.

### DETAILED DESCRIPTION OF THE PREFERRED EMBODIMENTS

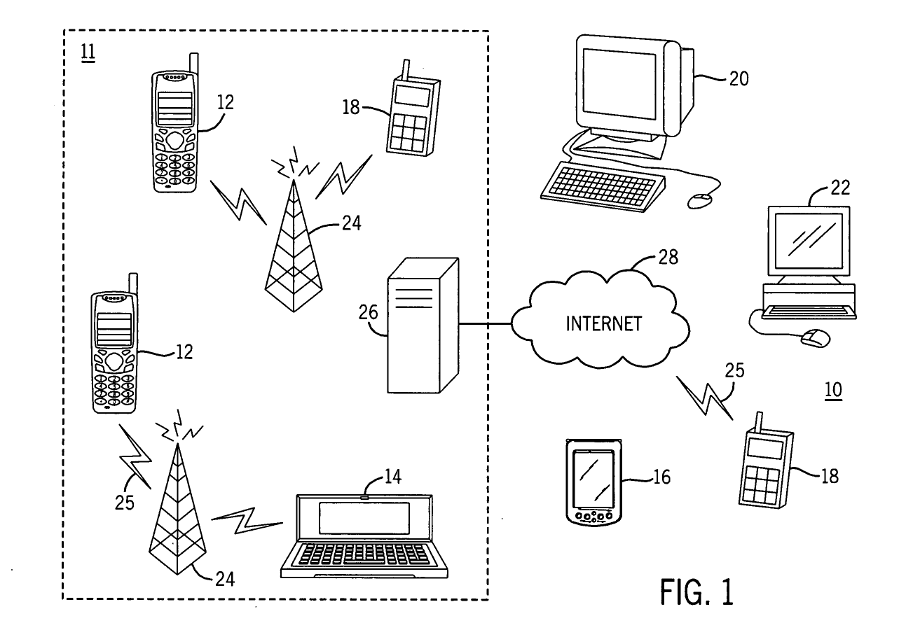

FIG. 1 shows a system 10 in which the present invention can be utilized, comprising multiple communication devices that can communicate through a network. The system 10 may comprise any combination of wired or wireless networks including, but not limited to, a mobile telephone network, a wireless Local Area Network (LAN), a Bluetooth personal area network, an Ethernet LAN, a token ring LAN, a wide area network, the Internet, etc. The system 10 may include both wired and wireless communication devices.

For exemplification, the system 10 shown in FIG. 1 includes a mobile telephone network 11 and the Internet 28. Connectivity to the Internet 28 may include, but is not limited to, long range wireless connections, short range wireless connections, and various wired connections including, but not limited to, telephone lines, cable lines, power lines, and the like.

The exemplary communication devices of the system 10 may include, but are not limited to, a mobile telephone 12, a combination PDA and mobile telephone 14, a PDA 16, an integrated messaging device (IMD) 18, a desktop computer 20, and a notebook computer 22. The communication devices may be stationary or mobile as when carried by an individual who is moving. The communication devices may also be located in a mode of transportation including, but not limited to, an automobile, a truck, a taxi, a bus, a boat, an airplane, a bicycle, a motorcycle, etc. Some or all of the communication devices may send and receive calls and messages and communicate with service providers through a wireless connection 25 to a base station 24. The base station 24 may be connected to a network server 26 that allows communication between the mobile telephone network 11 and the Internet 28. The system 10 may include additional communication devices and communication devices of different types.

The communication devices may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device may communicate using various media including, but not limited to, radio, infrared, laser, cable connection, and the like.

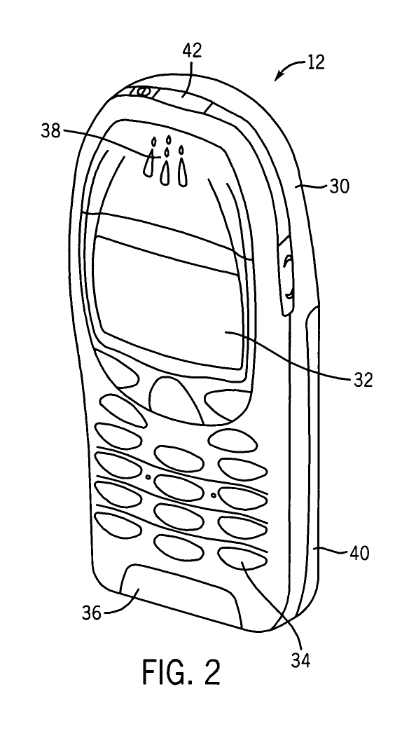

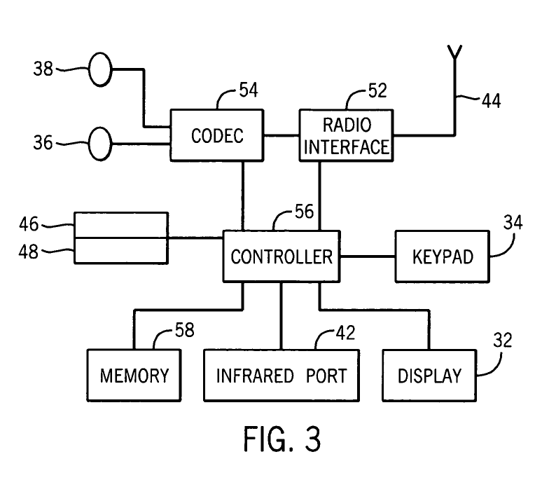

FIGS. 2 and 3 show one representative mobile telephone 12 within which the present invention may be implemented. It should be understood, however, that the present invention is not intended to be limited to one particular type of mobile telephone 12 or other electronic device. The mobile telephone 12 of FIGS. 2 and 3 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment of the invention, a card reader 48, radio interface circuitry 52, codec circuitry 54, a controller 56 and a memory 58. Individual circuits and elements are all of a type well known in the art, for example in the Nokia range of mobile telephones.

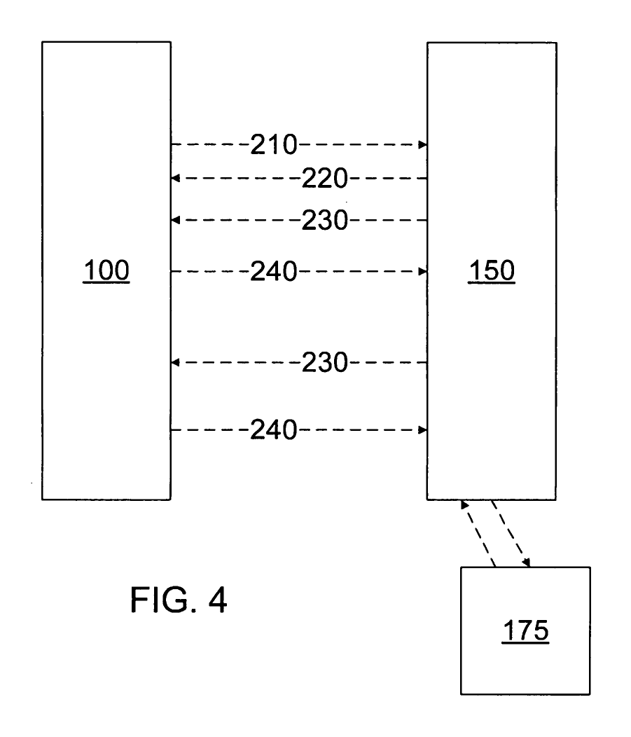

This present invention provides a system and method for applying the SIP SUBSCRIBE/NOTIFY framework in order to deliver RSS/Atom syndication feeds. A system in which the present invention is implemented comprises two primary components: a feed delivery server, represented at 150 in FIG. 4, and a feed consumption client, represented at 100 in FIG. 4. In one embodiment of the invention, the feed delivery server 150 comprises a SIP event server. Clients use a SIP SUBSCRIBE method to subscribe to the feed. In this situation, the feed consumption client 100 sends a SIP SUBSCRIBE request, represented at 210 in FIG. 4, to the feed delivery server 150, which transmits a subscription acknowledgment back to the feed consumption client 100 at step 220. The following is one example of a SIP SUBSCRIBE request according to the present invention:

SUBSCRIBE sip:resource@example.com SIP/2.0
Via: SIP/2.0/TCP watcherhost.example.com;branch=z9hG4bKnashds7
To: <sip:resource@example.com>
From: <sip:user@example.com>;tag=xfg9
Call-ID: 2010@watcherhost.example.com
CSeq: 17766 SUBSCRIBE
Max-Forwards: 70
Event: feed
Accept: application/atom+xml
Contact: <sip:user@watcherhost.example.com>
Expires: 600
Content-Length: 0

Once the feed consumption client 100 has subscribed to the feed, the feed delivery server 150 begins delivering new feed items using a SIP NOTIFY method. For example, when new information becomes available, the feed delivery server 150 transmits a SIP NOTIFY message at step 230 to the feed consumption client 100. In one embodiment of the invention, the SIP NOTIFY message transmits current state information and the updated content to the feed consumption client 100. In another embodiment of the invention, the SIP NOTIFY message only transmits the URL of the feed source 175 or a similar notification that the feed has changed, after which the feed consumption client 100 can regularly fetch the new material. The SIP NOTIFY message is acknowledged in a return message by the feed consumption client 100 at step 240. The following is an example of the notification process in computer code:

NOTIFY sip:user@watcherhost.example.com SIP/2.0
Via: SIP/2.0/TCP server.example.com;branch=z9hG4bKna998sk
From: <sip:resource@example.com>;tag=ffd2
To: <sip:user@example.com>;tag=xfg9
Call-ID: 2010@watcherhost.example.com
Event: feed
Subscription-State: active;expires=599
Max-Forwards: 70
CSeq: 8775 NOTIFY
Contact: sip:server.example.com
Content-Type: application/atom+xml
Content-Length: ...

<?xml version=“1.0” encoding=“utf-8”?>

<feed version=“draft-ietf-atompub-format-03: do not deploy”

xmlns=“http://purl.org/atom/ns#draft-ietf-atompub-format-03”>

<head>

<title>Example Feed</title>
<link href=“http://example.org/”/>
<updated>2003-12-13T18:30:02Z</updated>
<author>

<name>John Doe</name>

</author>

</head>
<entry>

<title>Atom-Powered Robots Run Amok</title>
<link href=“http://example.org/2003/12/13/atom03”/>
<id>vemmi://example.org/2003/32397</id>
<updated>2003-12-13T18:30:02Z</updated>

</entry>

</feed>

The feed that is provided to the feed consumption client 100 may be generated by the feed delivery server 150, or it may use any feed that is available on the network. If an existing feed is used, then the feed delivery server 150 needs to poll a feed source 175, check for new items, and then generate the SIP NOTIFY message for each subscribed feed consumption client 100 in one embodiment of the invention.

In another embodiment of the invention, the feed delivery server 150 does not have to continuously poll the feed source 175. In this particular embodiment, the feed source 175 can first transmit a SIP REGISTER message to the feed delivery server 150 in order to register with the feed delivery server 150. If the feed source 175 is updated at a later time, then the feed source 175 transmits a SIP PUBLISH message to the feed delivery server 150, which serves as a presence server. The feed delivery server 150 can then use this information to inform the feed consumption client 100 whenever an update of the feed source 175 has taken place.

The feed consumption client 100 may reside on a personal computer, a mobile device, or in virtually any other device that supports SIP. The feed consumption client 100 needs to implement the defined event package. The feed consumption client 100 needs to have a user interface for displaying the feed items, as well as a user interface to manage the respective subscriptions.

With the present invention, a new event package is standardized for Atom feed delivery. An event package defines (1) the name, parameters, and subscription duration of the package; (2) recommendations for the SIP SUBSCRIBE request body (for example, filters for the feed); (3) the SIP NOTIFY request body (i.e., the MIME type atom+xml); and (4) the SIP SUBSCRIBE and SIP NOTIFY request operation on the user agent client (UAC) and the user agent server (UAS).

As discussed above, the implementation of the present invention requires a feed delivery server 150 and a feed consumption client 100. The feed delivery server 150 may be implemented as a standalone aggregator of feeds, or it may be integrated into a content server. The feed consumption client 100 implementation may vary depending upon the intended usage. The feed consumption client 100 can take the form of a stand-alone application, or it may be integrated into some other application such as a messaging client. The feed consumption client 100 may also be part of the device user interface, such as an “active idle” user interface.

The technical requirements for the present invention are generally as follows in a situation where the feed consumption client 100 comprises a mobile telephone 12. However, the present invention can be used in conjunction with a wide variety of electronic devices. For the SIP stack on the mobile telephone 12, the mobile telephone 12 needs to have the SIP stack active while there is an outstanding subscription. Networks need to allow incoming SIP traffic to the mobile telephone 12. An aggregator can also be used for converting periodic HTTP GET request results into NOTIFY events. One example of an aggregator can be found at the web site http://www.bloglines.com. In one embodiment of the invention, the feed suppliers can provide NOTIFY events directly to the feed consumption client 100.

The system and method of the present invention can be implemented in several use cases. In addition to the basic feed delivery system depicted in FIG. 4, this system can be used in “Active Idle” situations. An Active Idle mode provides access to operator-branded links, e.g. portals, games, downloadable ring-tones, etc. while the electronic device at issue is not being actively used. The Active Idle system can implement a real-time updateable service, such as a news service, that is used to push content to the terminal using the present invention. The user can interact with these pushed content “snippets” by performing actions such as following URL links in the snippets. Active Idle can provide the user with information from native applications, such as unread SMS messages, unread e-mail messages, new voice messages, etc. Active Idle can provide easy access to native applications, such as contact lists, calendars, media players, etc. An Active Idle system is often highly customizable, providing the user with the ability to create his or her own look and feel in the application.

The present invention can also be used in the area of closed user groups. For example, the present invention can be used in conjunction with discussion boards and weblogs so that a reader is provided with an instant notification of any changes and/or additional information being posted. Instances where this can be particularly useful include situations where a message is added to a thread in a discussion group, or when a particular web log has new information added. Additionally, by adding XML configuration access protocol (XCAP) resource list-based group management, each subscription can be authenticated.

The present invention can also constitute an add-on to the SIP conferencing framework. Existing SIP-based conferences can also deliver a subscription-based news feed. In this situation, the benefit is derived from existing addressing and authorization in an ongoing conference.

The present invention is described in the general context of method steps, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule based logic and other logic to accomplish the various database searching steps, correlation steps, comparison steps and decision steps. It should also be noted that the words “component” and “module,” as used herein and in the claims, is intended to encompass implementations using one or more lines of software code, and/or hardware implementations, and/or equipment for receiving manual inputs.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. A method for delivering feed information to a feed consumption client, comprising:
receiving a subscription request from the feed consumption client; and
upon new feed information becoming available, transmitting a notify event to the feed consumption client.

2. The method of claim 1, wherein the notify event includes the new feed information.

3. The method of claim 1, wherein the feed information comprises a RSS feed.

4. The method of claim 1, wherein the feed information comprises an Atom feed.

5. The method of claim 1, further comprising:
polling a feed source to determine whether the new feed information is available; and
if the new feed information is available, obtaining the new feed information from the feed source for transmission to the feed consumption client.

6. The method of claim 1, further comprising receiving a publish event from a feed source when the new feed information becomes available, and wherein the notify event is transmitted to the feed consumption client in response to receipt of the publish event from the feed source.

7. The method of claim 1, wherein the feed information is used in an Active Idle system on the feed consumption client.

8. A computer program product for delivering feed information to a feed consumption client, comprising:
computer code for, upon receiving a subscription request from the feed consumption client, transmitting a subscription acknowledgment to the feed consumption client; and
computer code for, upon new feed information becoming available, transmitting a notify event to the feed consumption client.

9. The computer program product of claim 8, wherein the notify event includes the new feed information.

10. The computer program product of claim 8, further comprising:
computer code for polling a feed source to determine whether the new feed information is available; and
computer code for, if the new feed information is available, obtaining the new feed information from the feed source for transmission to the feed consumption client.

11. The computer program product of claim 8, further comprising computer code for receiving a publish event from a feed source when the new feed information becomes available, and wherein the notify event is transmitted to the feed consumption client in response to receipt of the publish event from the feed source.

12. A feed subscription client device, comprising:
a processor;
a data communication link operatively connected to the processor; and
a memory unit operatively connected to the processor and including:
computer code transmitting a feed subscription request to a feed delivery server,
computer code for receiving a subscription acknowledgment from the feed delivery server, and
computer code for automatically receiving a notify event from the feed delivery server when new feed information becomes available.

13. The feed subscription client device of claim 12, wherein the notify event includes the new feed information.

14. The feed subscription client device of claim 12, further comprising using the new feed information for exhibition when the feed subscription client device has entered an active idle mode.

15. The feed subscription client device of claim 12, wherein the feed information comprises information collected from at least one web log.

16. A feed delivery server device, comprising:
a processor;
a data communication link operatively connected to the processor for communicating with a feed subscription client; and
a memory unit operatively connected to the processor and including:
computer code for receiving a subscription request from the feed consumption client, and
computer code for, upon new feed information becoming available, transmitting a notify event to the feed consumption client.

17. The feed delivery service device of claim 16, wherein the notify event includes the new feed information.

18. The feed delivery server device of claim 16, wherein the memory unit further comprises:
computer code for polling a feed source to determine whether the new feed information is available; and
computer code for, if the new feed information is available, obtaining the new feed information from the feed source for transmission to the feed consumption client via the data communication link.

19. The feed delivery server device of claim 16, wherein the memory unit further comprises computer code for receiving a publish event from a feed source when the new feed information becomes available, and wherein the notify event is transmitted to the feed consumption client in response to receipt of the publish event from the feed source.

20. A system for providing feed information, comprising:
a feed subscription client device including computer code for transmitting a subscription request;
a feed delivery server device in at least selective communication with the feed subscription client device, the feed delivery server device configured to receive the subscription request in order to subscribe the feed subscription client device to receive feed information, and wherein the feed delivery server device includes computer code for, upon new feed information becoming available, transmitting a notify event to the feed consumption client.

21. The system of claim 20, wherein the notify event includes the new feed information.

22. The system of claim 20, further comprising a feed source in at least selective communication with the feed delivery server device, and wherein the feed delivery server device includes:
computer code for polling the feed source to determine whether the new feed information is available; and
computer code for, if the new feed information is available, obtaining the new feed information from the feed source for transmission to the feed consumption client.

23. The system of claim 20, further comprising a feed source in at least selective communication with the feed delivery server device,
wherein the feed delivery server device includes computer code for transmitting a publish event to the feed delivery server when the new feed information becomes available, and wherein the notify event is transmitted to the feed consumption client from the feed delivery server in response to receipt of the publish event from the feed source.
